(19) United States
(12) Patent Application Publication
(10) Pub. No.: US 2013/0002685 A1
(43) Pub. Date: Jan. 3, 2013

(54) BONDED DOUBLE SUBSTRATE APPROACH TO SOLVE LASER DRILLING PROBLEMS

(75) Inventors: Ravindra V. Shenoy, Dublin, CA (US); Evgeni P. Gousev, Saratoga, CA (US)

(73) Assignee: QUALCOMM MEMS TECHNOLOGIES, INC., San Diego, CA (US)

(21) Appl. No.: 13/173,138

(22) Filed: Jun. 30, 2011

(51) Int. Cl. G06T 1/00; B32B 3/10; B32B 38/10; B32B 37/02; B32B 37/14

(52) U.S. Cl. 345/501; 156/247; 156/390; 156/379.6; 428/137; 428/138

(57) ABSTRACT

This disclosure provides systems, methods and apparatus for bonding a device substrate formed of a substantially transparent material to a carrier substrate. A laser etch stop layer may be formed on the device substrate. The carrier substrate may be coated with a releasable layer, such as a polymer layer. Vias may be formed in the device substrate by laser drilling. The vias may be filled with conductive material, e.g., by electroplating or by filling the vias with a conductive paste. One or more types of devices may then be attached to the device substrate and configured for electrical communication with the vias. In some implementations, passive devices may be formed on the device substrate before the vias are formed. Before or after device fabrication, the substrates may be separated. The substrates may be separated by laser irradiation or chemical dissolution of the releasable layer.

### TECHNICAL FIELD

This disclosure relates to display devices, including but not limited to display devices that incorporate touch screens.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Substrates with electrically conducting vias in a glass substrate can be used for a variety of applications, such as MEMS on glass and packaging applications.

### SUMMARY

The systems, methods and devices of the disclosure each have several innovative aspects, no single one of which is solely responsible for the desirable attributes disclosed herein.

One innovative aspect of the subject matter described in this disclosure involves a dual-substrate approach for solving laser drilling problems. In some implementations, two substrates may be bonded together to form a combined panel. One of the substrates (which may be referred to herein as a device substrate or a device panel) may include a laser etch stop layer on its bottom surface. The device substrate may be formed of a substantially transparent material, such as glass or any of a variety of transparent plastics. A second substrate (which may be referred herein as a carrier substrate or a carrier panel) may be coated with a releasable layer, such as a polymer layer. Vias may be formed in the device substrate by laser drilling. The vias may be filled with conductive material. One or more types of devices may be attached to or fabricated on the device substrate and configured for electrical communication with the vias. Before or after device fabrication, the substrates may be separated.

Some methods described herein involve joining a device panel and a carrier panel with a releasable layer to form a combined panel. Vias may be formed through the device panel, e.g., by laser drilling. The vias may be filled with conductive material. An integrated circuit and/or a sensor may be mounted on a first side of the device panel. The releasable layer may be removed to separate the device panel from the carrier panel.

Removing the releasable layer may involve laser irradiation of the releasable layer or performing wet etching of the releasable layer. The carrier panel may include openings configured for introducing wet etching solvent. The releasable layer may include a polymer. The combined panel may be divided into sub-panels prior to removing the releasable layer.

The vias may be formed at least partially into the releasable layer. The conductive material may protrude from a second side of the device panel after removing the releasable layer. However, in some implementations, a laser etch stop layer may be formed on a second side of the device panel.

The device panel may include a plurality of device sub-panels. Joining the device panel and the carrier panel may include joining the carrier panel with the plurality of device sub-panels. The method may involve dividing the combined panel into sub-panels by dividing the combined panel along interstices between the device sub-panels prior to removing the releasable layer.

The method may involve fabricating devices on the first side of the device panel prior to forming the vias. The devices may include at least one of a resistor, a capacitor or an inductor.

Devices formed according to such methods are described herein. For example, a display device may include a device panel formed according to the following process: joining the device panel and a carrier panel with a releasable layer to form a combined panel; forming vias through the device panel by laser drilling; filling the vias with conductive material; mounting an integrated circuit on a first side of the device panel; forming electrical connections between the integrated circuit and the conductive material; and removing the releasable layer to separate the device panel from the carrier panel.

In some implementations, the device panel includes substantially no stress concentration points on the device substrate. In some implementations, the device panel includes substantially no scratches on the device substrate.

The display device may include a display and a processor that is configured to communicate with the display. The processor may be configured to process image data. The display device may include a memory device that is configured to communicate with the processor. The display device may include an input device configured to receive input data and to communicate the input data to the processor.

The display device may include a driver circuit configured to send at least one signal to the display and a controller configured to send at least a portion of the image data to the driver circuit. The display device may include an image source module configured to send the image data to the processor. The image source module may include at least one of a receiver, transceiver, and transmitter.

Some systems described herein include apparatus for combining a device panel and a carrier panel, apparatus for forming vias through the device panel, apparatus for filling the vias with conductive material, and apparatus for separating the device panel from the carrier panel. The apparatus for removing the releasable layer may include laser devices configured to provide laser irradiation of the releasable layer. The apparatus for removing the releasable layer may include apparatus for removing the releasable layer by a wet etching process. The system may include apparatus for forming a laser stop layer on a second side of the device panel. The apparatus for filling the vias with conductive material may include electroplating apparatus.

Some apparatus described herein includes the following elements: a glass device panel; a device layer deposited on the device panel, the device layer including at least one passive device; a carrier panel; a releasable layer disposed between the device panel and the carrier panel; a plurality of vias extending through the device panel; and conductive material disposed in the plurality of vias. At least some vias of the plurality of vias may extend into the releasable layer. The apparatus may include a laser etch stop layer disposed between the releasable layer and the device panel. The apparatus may include an integrated circuit configured for electrical communication with the conductive material. The apparatus may include an underfill layer disposed between the integrated circuit and the device layer. The apparatus may include an overcoat layer formed over the integrated circuit.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a flow diagram illustrating a high-level process of fabricating devices according to a dual substrate approach.

FIGS. 10A through 10F show examples of device cross-sections during various stages of the process depicted in FIG. 9.

FIG. 10G shows an example of a perspective view of a combined panel that includes multiple sub-panels.

FIG. 11A shows an example of a flow diagram illustrating an alternative process of fabricating devices according to a dual substrate approach.

FIG. 11B shows an example of a block diagram illustrating a system for fabricating devices according to a dual substrate approach.

FIGS. 12A through 12F, 13A through 13E, 14A through 14D, 15A and 15B show examples of device cross-sections during various stages of the process depicted in FIG. 11A.

FIGS. 16A and 16B show examples of system block diagrams illustrating a display device that may include one or more devices fabricated as described herein.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

According to some implementations provided herein, a device substrate may be bonded to a carrier substrate. In some implementations, the carrier substrate may have a thickness of about 0.5 mm or less. In some such implementations, a laser etch stop layer may be formed on the device substrate. The device substrate may be formed of a substantially transparent material, such as glass. The carrier substrate may be coated with a releasable layer, such as a polymer layer. In some implementations, the carrier substrate may include multiple sections. For example, the carrier substrate may include rows and/or columns with interstitial gaps. The locations of the carrier substrate rows and/or columns may correspond with the locations of handling fixtures used in a fabrication facility for holding and/or positioning the combined stack.

Vias may be formed in the device substrate by laser drilling. The vias may be filled with conductive material, e.g., by electroplating or by filling the vias with a conductive paste. One or more types of devices may then be attached to or fabricated on the device substrate and configured for electrical communication with the vias. In some implementations, devices (such as passive devices) may be formed on the device substrate before the vias are formed. In some implementations, one or more devices may be formed on the device substrate, with metallization in the vias being part of the device(s).

Before or after device fabrication, the substrates may be separated. In some implementations, the substrates may be separated by laser irradiation of the releasable layer. The substrates may be broken or diced into sub-panels prior to the laser irradiation process. In alternative implementations, the substrates may be separated via a chemical process. For example, a solvent may be introduced through holes in the carrier substrate.

In alternative implementations, no laser etch stop layer is formed on the device substrate. Vias may be formed in the device substrate and partially through the releasable layer by laser drilling. When the vias are filled with conductive material, some of the conductive material may extend into the releasable layer. After the releasable layer is removed, conductive material may protrude from the vias and extend beyond the surface of the device substrate. Such features may make it easier to form an electrical connection through the vias and may eliminate the need to form conducting pads.

Particular implementations of the subject matter described in this disclosure can be implemented to realize one or more of the following potential advantages. The combined substrates are more resistant to breakage than a single device substrate. Such a structure may form a large panel, such as a Gen 4 (680×880 mm), a Gen 5 (1100×1300 mm), a Gen 6 (1500×1850 mm), or larger substrate size, and may be handled by conventional fabrication equipment without a substantial risk of damage. Vias may be rapidly formed through a large-area glass device substrate.

When the device substrate thickness increases (e.g., to on the order of 500 μm) while the aspect ratio of the vias is maintained, the via diameter increases. The increase in via diameter and the increased device substrate thickness can cause an increase in the volume of material (e.g., of glass) that needs to be ablated. Moreover an increase in the device substrate thickness can degrade the via sidewall profile, increasing the side wall angle from the vertical, which is not desirable. Maintaining a nearly vertical sidewall profile would require slowing down the laser ablation process and frequent refocusing of the laser. The two factors together may lead to a significant decrease in throughput. The dual-substrate implementations described herein can be implemented to reduce such undesirable characteristics.

Moreover, if devices (e.g., passive devices, EMS or MEMS devices) are fabricated on a device substrate having a thickness greater than that which will be used in the final product, the device substrate may require back-grinding, etching, lapping and/or polishing. Such processes are time-consuming, cause additional expenses and pose reliability issues. Such processes can leave scratches and stress concentration points on the device substrates. Among other potential advantages, the dual-substrate implementations described herein can prevent such damage to the device substrate. Accordingly, devices produced according to such implementations may be produced with substantially no scratches and/or stress concentration points on the device substrates.

Some implementations described herein enable the use of a large-panel glass fabrication factory infrastructure, for example an infrastructure designed for panels of glass having a thickness of approximately 0.5 mm, 0.7 mm or 1.1 mm, to be used for fabricating devices with through-glass vias on relatively thinner glass substrates (e.g., having a thickness of approximately 0.3 mm, 0.25 mm, 0.2 mm, 0.1 mm or 0.05 mm) without significant changes to the factory glass panel handling toolset. Such implementations may enable the use of lithography processes currently used in a large-panel glass factory without the problems of panel bow and/or panel warping caused by thinner glass substrates and their adverse impact in fine line definition and patterning capability. Such approaches may enable the use of sputter deposition processes currently used in large-panel glass factories without the problems of panel bow and/or warping in thinner glass substrates that may otherwise be caused by stresses in the substrates.

According to some implementations, flexible glass device substrates (e.g., on the order of ˜0.1 mm) can be processed as thicker and more rigid substrates (e.g., on the order of approximately 0.5 mm to 1.1 mm), yet the resulting device substrate thickness will be that of the flexible glass substrates. In some implementations, roll-on-roll glass substrates can use the fabrication facility of a large-panel glass factory without the need for extensive re-tooling of the entire factory.

The use of finer lithographic resolution may be enabled on relatively thinner glass substrates, finer that which may be possible with a rigid large glass panel process. For example, a typical large-panel fabrication facility can provide a resolution of 3 μm line/space or finer, whereas flexible roll on roll processing can fabricate devices at a 25 μm line/space resolution.

An example of a suitable electromechanical systems (EMS) or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

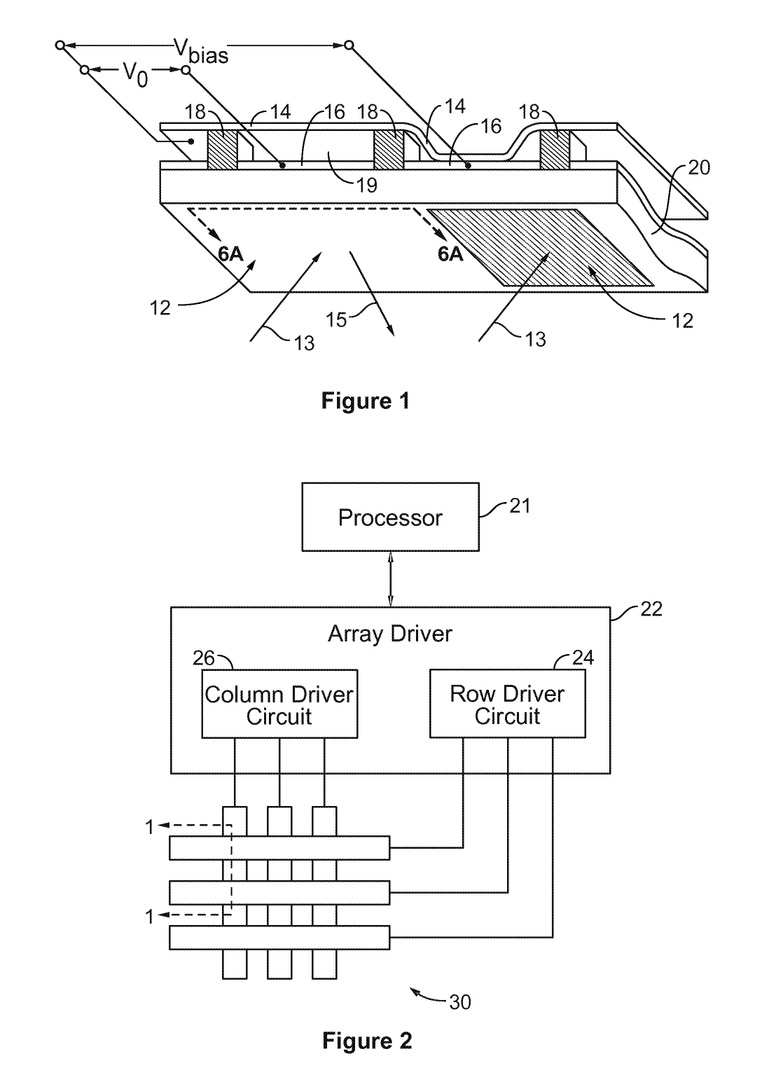

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the IMOD 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated IMOD 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

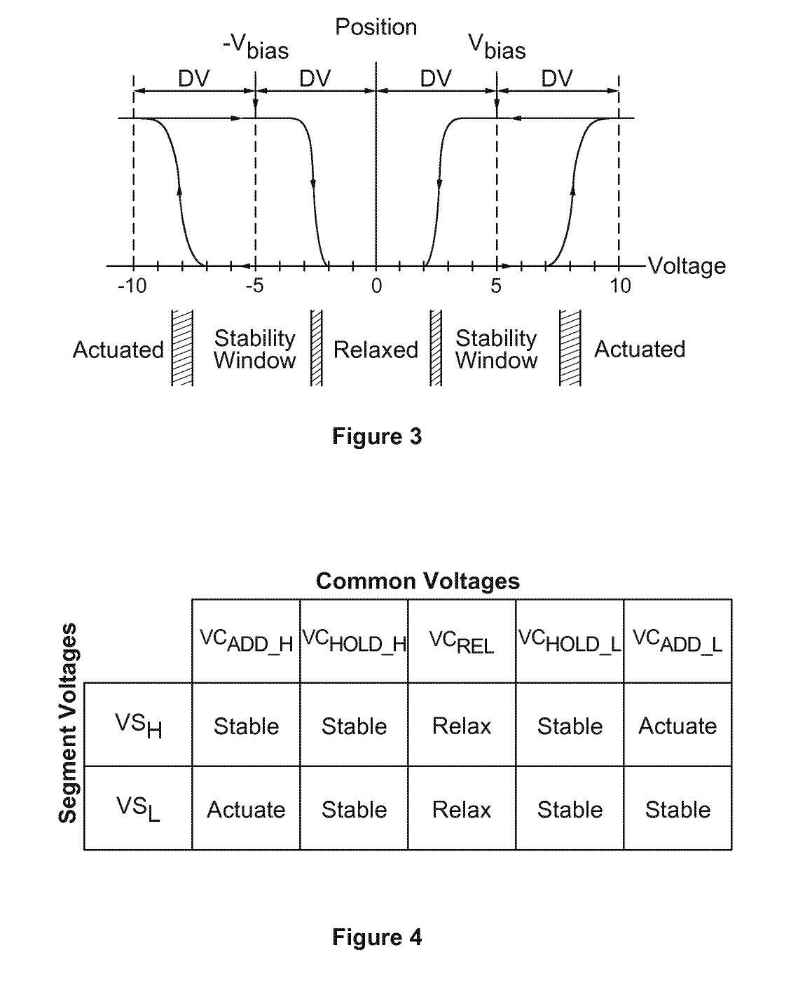

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10 volts. However, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10 volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7 volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

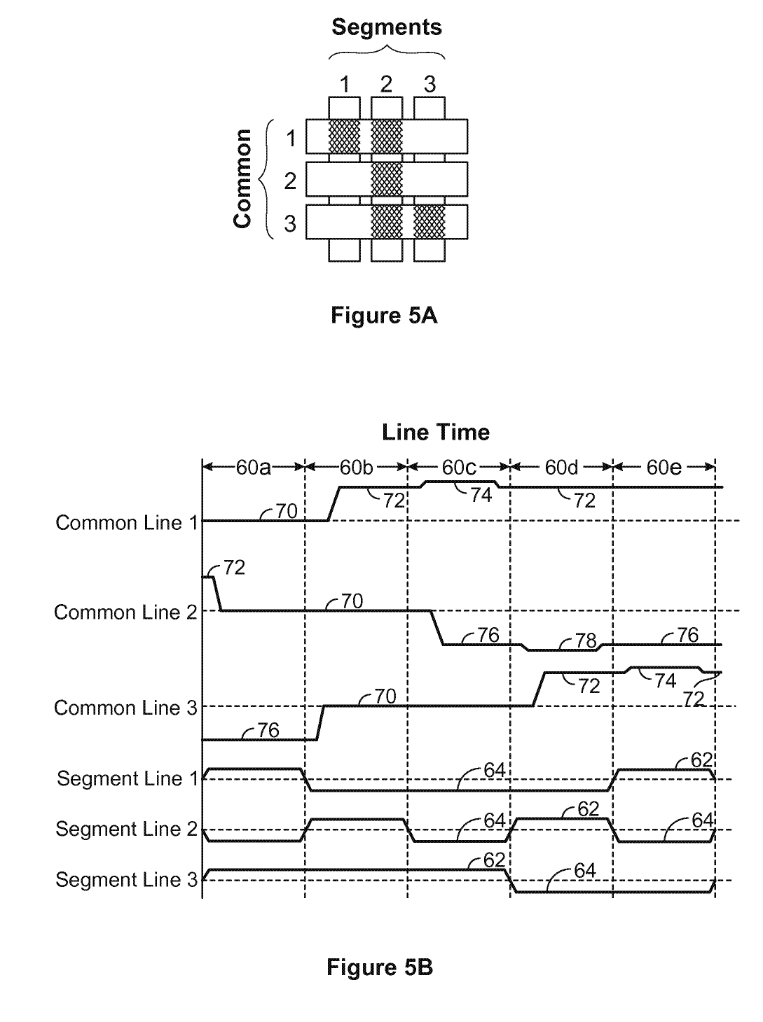

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a, a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}−relax and VC_{HOLD}_{_{—}}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

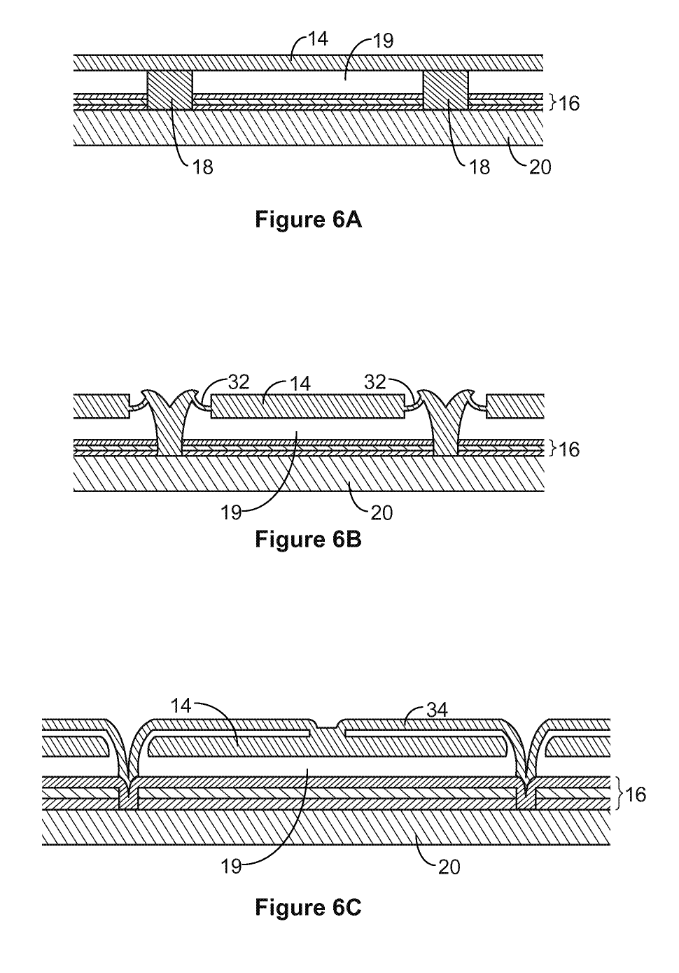

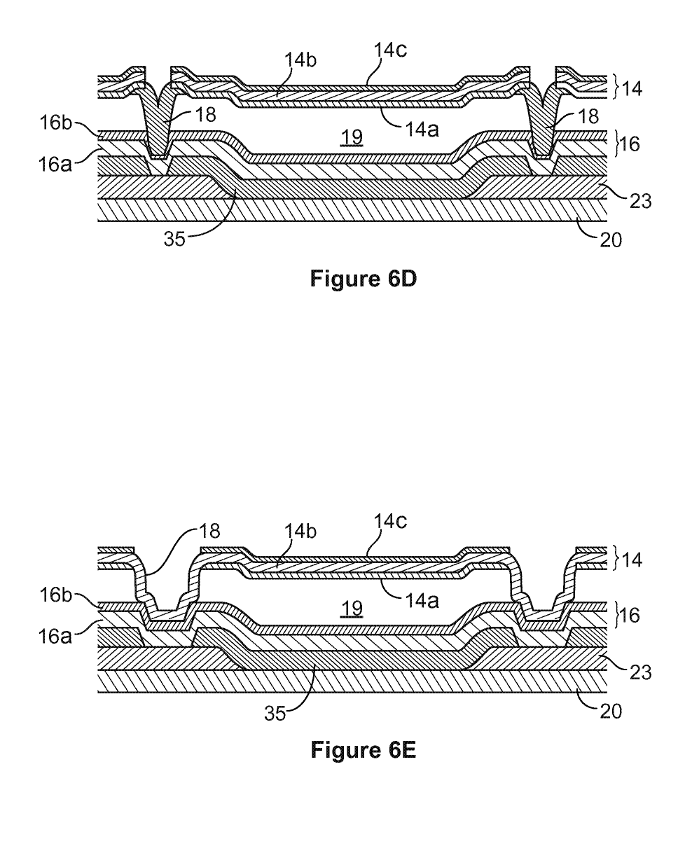

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

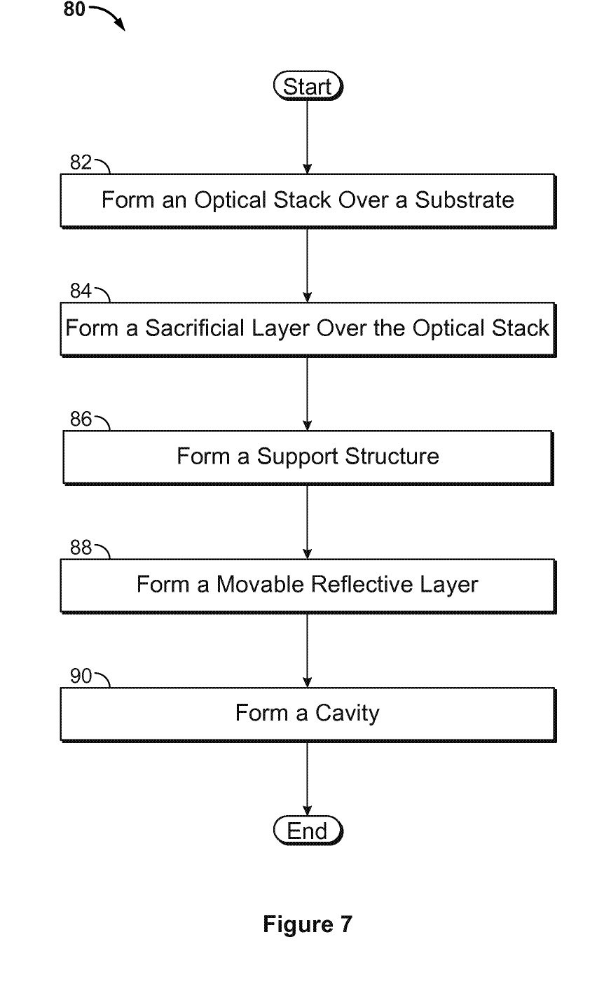

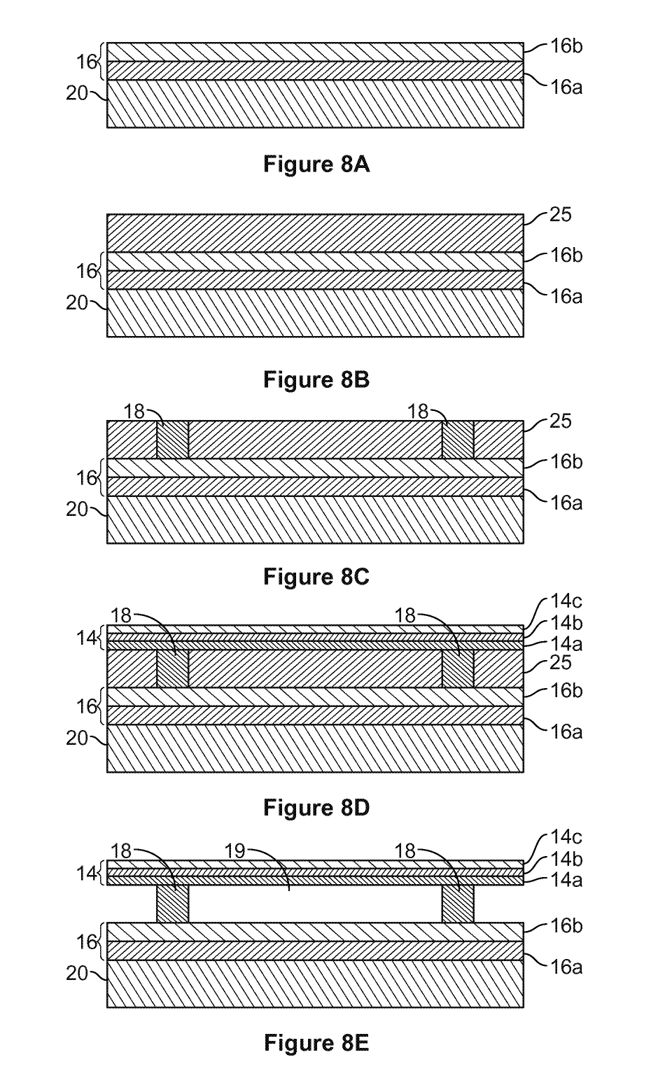

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition processes, e.g., reflective layer (e.g., aluminum, aluminum alloy) deposition, along with one or more patterning, masking, and/or etching processes. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other combinations of etchable sacrificial material and etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

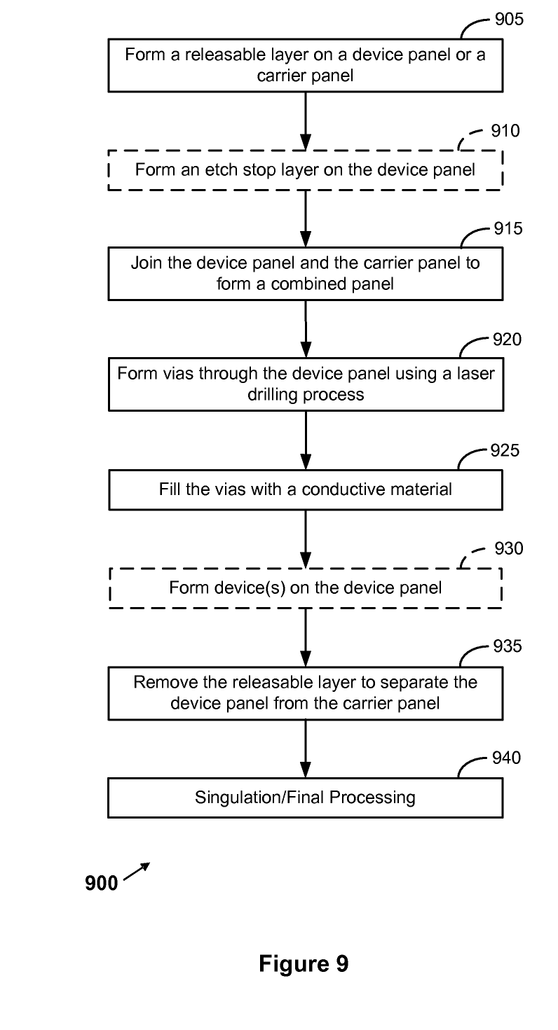

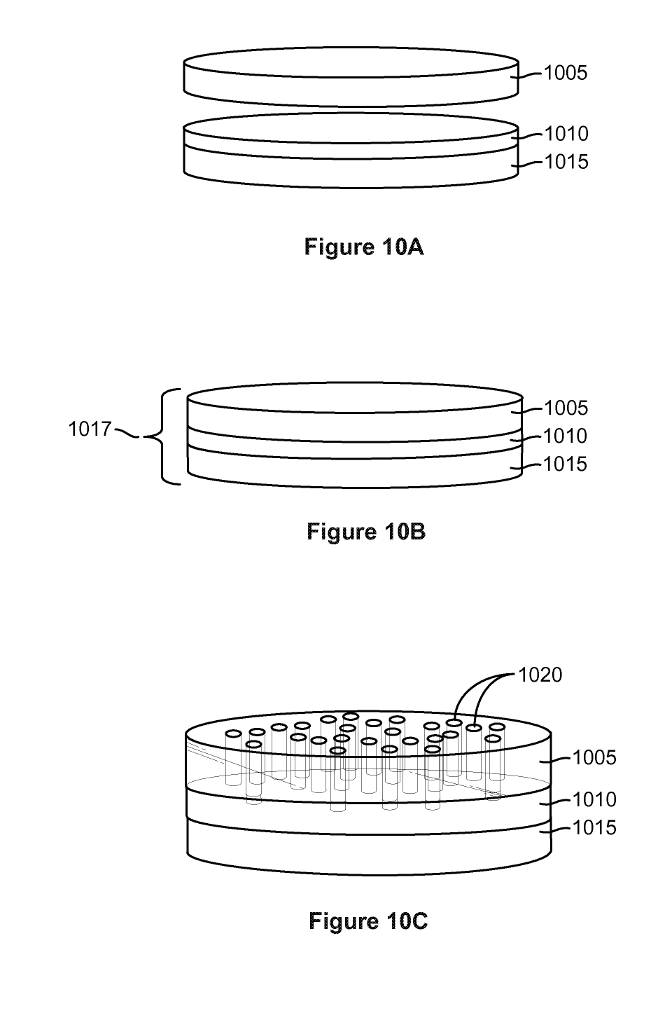

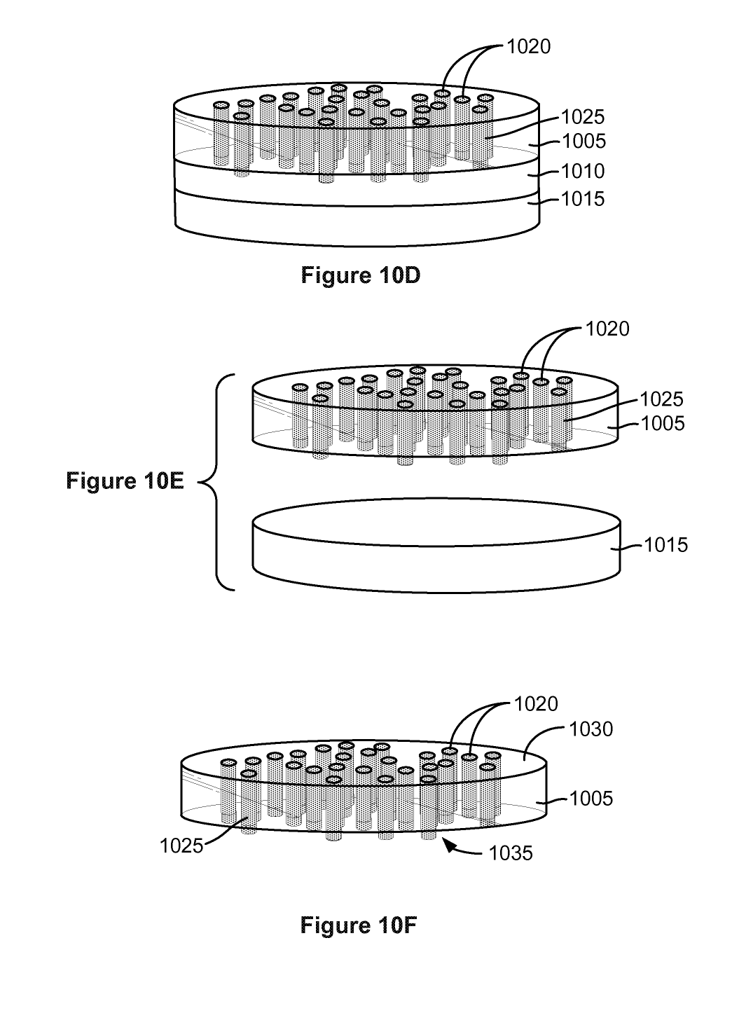

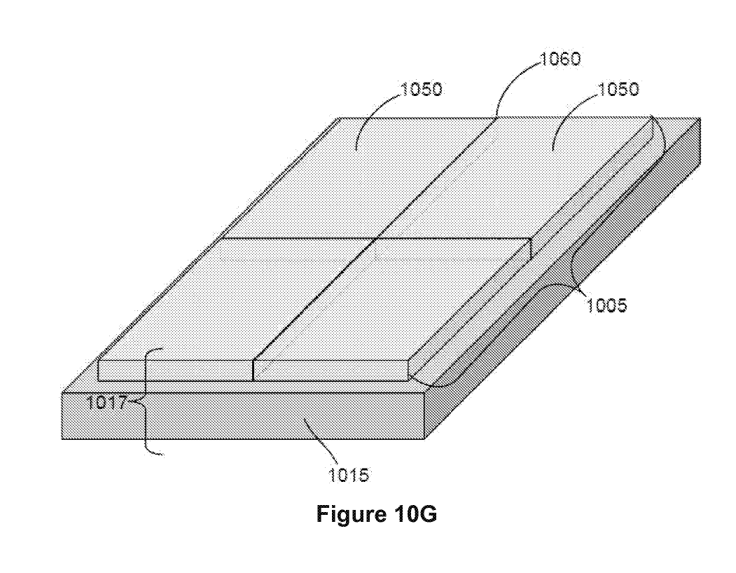

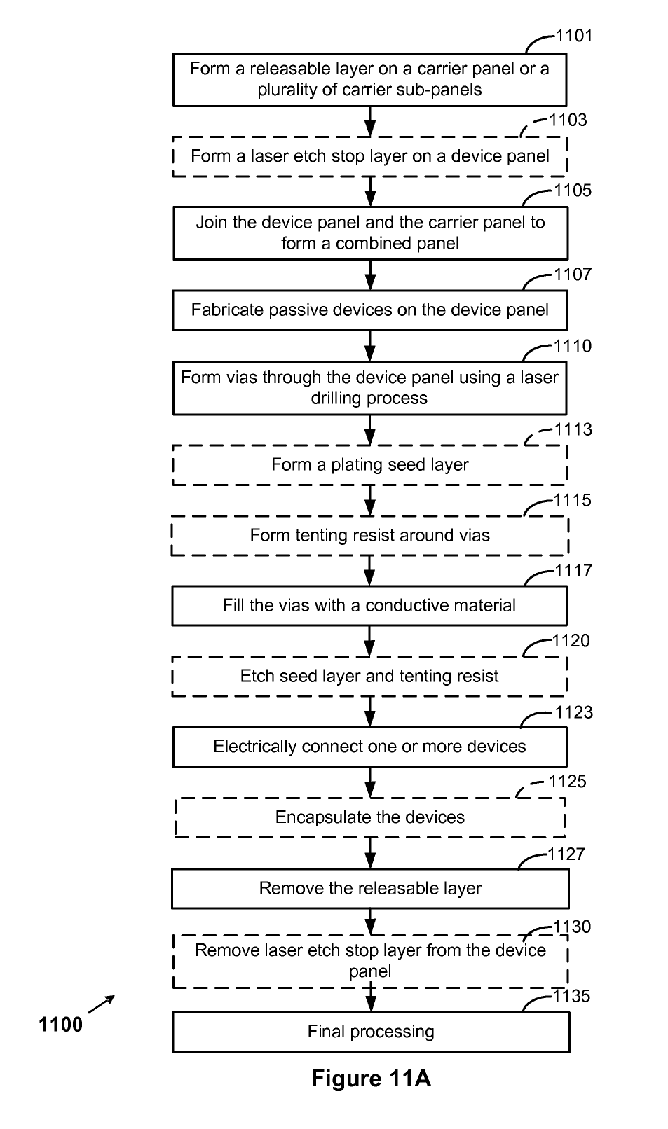

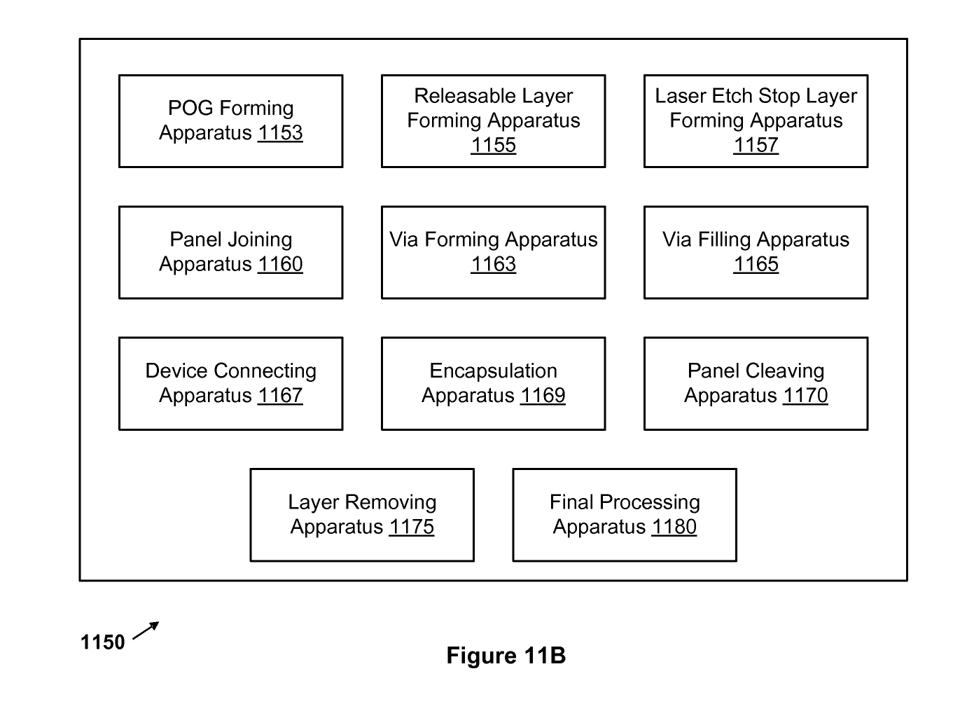

FIG. 9 shows an example of a flow diagram illustrating a high-level process of fabricating devices according to a dual substrate approach. The blocks of process 900 are described below with reference to FIGS. 10A through 10F. An example of a more detailed process is set forth below with reference to FIG. 11 et seq. As with other flow diagrams shown and described herein, the blocks are not necessarily ordered as indicated. For example, the order of the blocks may be changed to singulate individual devices by different methods. Different implementations of the process may include more or fewer blocks than are indicated.

Process 900 begins with block 905, in which a releasable layer is formed on a substrate. The substrate may be referred to herein as a “carrier panel.” The carrier panel may be formed of any appropriate material, such as glass, ceramic, plastic, metallized plastic, silicon, etc. In some implementations, the carrier panel may be formed of borosilicate glass. The releasable layer may be, for example, a polymer. Additional examples of materials for the releasable layer, as well as methods of applying the releasable layer to a substrate, are provided below. In some implementations, the releasable layer may be formed on another substrate, which may be referred to herein as a device panel.

FIGS. 10A through 10F show examples of device cross-sections during various stages of the process of FIG. 9. Here, the releasable layer 1010 is formed on the carrier panel 1015. However, in other implementations, the releasable layer 1010 may be formed on the device panel 1005. The device panel 1005 may be formed of various materials, but in this example it is formed of a substantially transparent material, such as glass. The device panel 1005 may be formed of a material having a coefficient of thermal expansion that is substantially matched with that of the carrier panel 1015.

Referring back to FIG. 9, the process 900 can optionally transition from block 905 to block 910. In block 910, an etch stop layer is formed on the device panel. The etch stop layer may be formed of a reflective material, such as chrome or copper. Then the process 900 can transition from block 910 to block 915. Alternatively, the process 900 may transition from block 905 directly to block 915 without going through block 910. In block 915, the device panel and the carrier panel can be joined to form a combined panel in some implementations.

FIG. 10B shows an example of a combined panel. Although an etch stop layer may be formed on the device panel in some implementations described below (see optional block 910 of FIG. 9), in this example of the combined panel 1017, the releasable layer 1010 attaches the carrier panel 1015 directly to the device panel 1005. The combined panel 1017 may be formed, for example, by pressing the device panel 1005 and the carrier panel 1015 together, then curing the releasable layer 1010 by heating, or by exposure to ultraviolet light, etc.

In some implementations, the device panel 1005 and the carrier panel 1015 are on the order of hundreds of microns in thickness. For example, the device panel 1005 may be in the range of 50 μm to 200 μm in thickness and the carrier panel 1015 may be in the range of 200 μm to 600 μm in thickness. The device panel 1005 and the carrier panel 1015 also may be larger in some implementations. The releasable layer 1010 may be tens of microns to hundreds of microns in thickness. For example, the releasable layer 1010 may be in the range of about 50 to 150 microns in thickness.

In block 920, vias are formed through device panel 1005. In FIG. 10C, some examples of the vias 1020 are shown. The vias 1020 may be formed in various ways, such as DRIE. However, in this example the vias 1020 are formed by laser drilling, also known as laser ablation or laser micromachining. For example, a YAG (yttrium aluminum garnet) laser, an excimer laser, a CO₂ laser or an ultraviolet laser may be used to form the vias 1020. The vias 1020 may be formed in any appropriate diameter, e.g., in the range of tens of microns to hundreds of microns. In some implementations, the vias 1020 are formed with diameters in the range of approximately 50 μm to 100 μm.

In one implementation, by using an excimer laser flash field of 1 mm×1 mm, hundreds of vias having a diameter of about 25 μm and a depth of about 200 μm may be formed in a glass substrate. The vias may have an aspect ratio of approximately 1:8. The substrates involved in this implementation are 6-inch wafers that are about 200 μm thick.

However, for commercial purposes a significantly larger panel size can be used to achieve economies of scale. A large device panel that is on the order of about 200 μm in thickness may not easily be handled without the risk of damage. However, if one increases the substrate thickness (e.g., to about 500 μm) while maintaining the aspect ratio, the via diameter increases. The process takes longer and the shape of the hole is harder to control. These factors can lead to a significant decrease in the throughput for laser via processes.

The combined panel 1017 can provide a solution to such problems. In some implementations, the combined panel 1017 may be on the order of about 500 to 800 microns thick. The combined panel 1017 can be more resistant to breakage than a single thinner substrate. Even if the combined panel 1017 is made into a large format, such as a Gen 4 (680×880 mm), a Gen 4.5 (730 mm×920 mm), a Gen 5 (1100×1300 mm), a Gen 6 (1500×1850 mm) or larger substrate size, the combined panel 1017 may nonetheless be handled by equipment that is currently deployed in some fabrication facilities without a substantial risk of damage.

The vias 1020 are filled with conductive material in block 925. Block 925 may involve an electroplating process. Prior to electroplating, a seed layer may first be deposited in the vias 1020. Alternatively, block 925 may involve filling the vias 1020 with a conductive paste. For example, block 925 may involve a process of dispensing conductive paste directly into the vias 1020 (e.g., using syringes to deliver the conductive paste) and/or a process of spreading the conductive paste onto the top of the device panel 1005. In some implementations, the conductive paste may be thermally cured before further processing.

As described below, in implementations that involve forming a laser etch stop layer on the bottom of the device panel 1005, the vias 1020 do not generally extend into the releasable layer 1010. However, this example does not involve forming a laser etch stop layer on the device panel 1005. Therefore, it may be observed in FIG. 10C that the vias 1020 are formed at least partially into the releasable layer 1010. Referring to FIG. 10D, it may be seen that when the vias 1020 are filled with the conductive material 1025 in block 925, the conductive material 1025 also extends partly into the releasable layer 1010.

In some alternative implementations, the process 900 transitions from block 925 to optional block 930, in which devices are formed on the device panel 1005. Alternatively, devices may be formed before the device panel 1005 is joined with the carrier panel 1015 to form the combined panel 1017. Some such implementations are described in more detail below with reference to FIG. 11A et seq.

Referring back to FIG. 9, the process 900 transitions from block 930 to block 935. In block 935, the releasable layer is removed to separate the device panel from the carrier panel, and then the process 900 ends at block 940. For example, in FIG. 10E, the device panel 1005 is separated from the carrier panel 1015. Referring to FIG. 10F, it may be seen that when the device panel 1005 is separated from the carrier panel 1015, the conductive material 1025 extends beyond the bottom surface 1035 of the device panel 1005. Accordingly, the conductive material 1025 extends from the top surface 1030, through the device panel 1005 and beyond the bottom surface 1035. Electrical connections may accordingly be made through the device panel 1005. Moreover, those portions of the conductive material 1025 that extend beyond the bottom surface 1035 may allow electrical connections to be made conveniently along the bottom surface 1035. In some implementations, electrical connections along the bottom surface 1035 can be made without forming pads or other structures.

In this example, laser irradiation is used to cleave the releasable layer 1010 from the combined panel 1017. In some such implementations, the combined panel 1017 may be divided into sub-panels before laser irradiation of the releasable layer 1010. Breaking or dicing the combined panel 1017 into sub-panels may facilitate the process of cleaving the releasable layer for various reasons, such as, because the laser irradiation may have to be performed over a relatively smaller optical path.

In some implementations, the carrier panel 1015 or the device panel 1005 may not be a continuous sheet, but instead may be divided into sections. According to some such implementations, sections of the device panel 1005 may correspond to the sub-panel sizes. Accordingly, the breaks or cuts through the combined panel 1017 can be made through the carrier panel 1015, along interstices between the sections of the device panel 1005. The device panel sections may be formed into rows, columns, or other appropriate configurations.

FIG. 10G shows an example of a perspective view of a combined panel that includes multiple sub-panels. Here, the device panel 1005 includes multiple sub-panels 1050, separated by interstices 1060. The shapes and sizes of the sub-panels 1050 and the interstices 1060 are merely made by way of example. In such implementations, sub-panels 1050 can be formed so that handling fixtures of a fabrication facility can grasp the entire thickness of the combined panel 1017 or only the carrier panel 1015. For example, sub-panels 1050 may be formed to correspond with known locations of the combined panel 1017 that will be grasped by such handling fixtures, in order to ensure that the handling fixtures do not grasp the relatively weaker interstices 1060 of the combined panel 1017.

In alternative implementations, the carrier panel 1015 may be released at the die level. The device panel 1005 and the carrier panel 1015 may be separated into individual dice before removing the releasable layer 1010. In some such implementations, the device panel 1005 may be diced using blade dicing, laser dicing or a scribe and break method. However, the individual dice may be held together by the carrier panel 1015. The dicing may be done only through the device panel 1005. The individual dice may be singulated once the releasable layer 1010 is cleaved. According to some such implementations, the singulated dice may be released at substantially the same time and may be picked up by a pick and place tool for subsequent processing.

In some implementations, a wet chemical dissolution agent may be used to release the device panel 1005 from the carrier panel 1015. In some such implementations, the dissolution agent may be introduced through pre-fabricated holes in the carrier panel 1015. If the device panel 1005 is formed into sections, the interstices 1060 between sections of the device panel 1005 may facilitate the introduction of solvent and/or the removal of dissolved material from the releasable layer 1010. In block 940, singulation and/or final processing may be performed. Some examples are described below with reference to FIG. 11A.

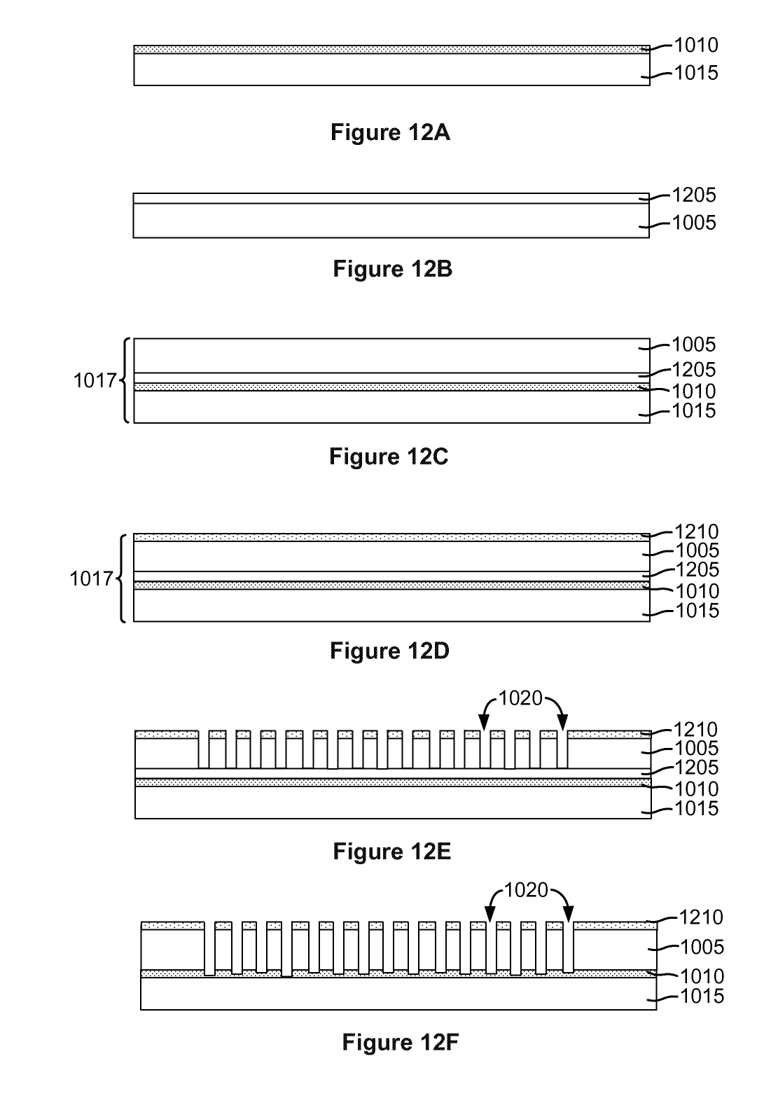

FIG. 11A shows an example of a flow diagram illustrating an alternative process of fabricating devices according to a dual substrate approach. The blocks of process 1100 are described below with reference to FIG. 11B et seq. FIG. 11B shows an example of a block diagram illustrating a system 1150 for fabricating devices according to a dual substrate approach. FIGS. 12A through 12F, 13A through 13E, 14A through 14D, 15A and 15B show examples of device cross-sections during various stages of some implementations of the process depicted in FIG. 11A.

Process 1100 begins with block 1101, wherein a releasable layer is formed on a carrier panel or a set of carrier sub-panels. FIG. 12A shows an example of a cross-section through a carrier panel 1015 and a releasable layer 1010 after the process of block 1101.

The releasable layer 1010 may be formed of a variety of materials. For example, a polymer layer, such as a benzocyclobutene (BCB)-based polymer, may be used to form the releasable layer 1010. Dow Chemical Company provides a variety of suitable BCB-based polymers. Alternatively, the releasable layer 1010 may be a photosensitive epoxy, such as one of the SU-8 family of compounds commercially available from MicroChem. Corporation. The releasable layer 1010 could be formed of one of the HD7000-series materials provided by HD MicroSystems™. Alternatively, one of the GM1040, GM1060, GM1070 or GLM2060 compounds commercially available from Gersteltec SARL may be used to form the releasable layer 1010.

Block 1101 may be performed by the releasable layer forming apparatus 1155 of FIG. 11B. The releasable layer forming apparatus 1155 may include various devices, according to the properties of the releasable layer 1010 and how the releasable layer 1010 is applied to the carrier panel(s) 1015. For example, SU8 is available either in a film or a liquid form. Accordingly, the releasable layer forming apparatus 1155 may include devices for applying a film of SU8 to the carrier panel(s) 1015, such as film lamination apparatus.

Alternatively, the releasable layer forming apparatus 1155 may include devices for dispensing the liquid form of SU8 to the carrier panel(s) 1015. For example, the releasable layer forming apparatus 1155 may include apparatus for spraying liquid across the carrier panel(s) 1015. The releasable layer forming apparatus 1155 may include devices for dispensing liquid and devices for spinning the carrier panel(s) 1015, in order to spin-coat the releasable layer 1010 on the carrier panel(s) 1015. Alternatively, the releasable layer forming apparatus 1155 may include apparatus (such as a squeegee) for spreading the liquid releasable layer 1010 evenly on the carrier panel(s) 1015.

Process 1100 continues with block 1103, wherein a laser etch stop layer is formed on a device panel. FIG. 12B shows an example of a cross-section through a device panel 1005 and a laser etch stop layer 1205 after the process of block 1103. The laser etch stop layer 1205 may be formed of a reflective material, such as chrome or copper, that reflects the laser beams used to form the vias in block 1110.

Block 1103 may be performed by the laser etch stop layer forming apparatus 1157 of FIG. 11B. The laser etch stop layer forming apparatus 1157 may include various devices, such as sputtering apparatus for sputtering a film of metal (such as chromium, copper or titanium) onto the device panel 1005. Alternatively, the laser etch stop layer forming apparatus 1157 may include laminating devices for applying a pre-existing film of reflective material (such as metal or a combination of dielectric layers with specific optical properties) to the device panel 1005.

In block 1105, the device panel and the carrier panel(s) are joined to form a combined panel. FIG. 12C shows an example of a cross-section through the device panel 1005, the laser etch stop layer 1205, the releasable layer 1010 and the carrier panel 1015 or the carrier sub-panels after the process of block 1105.

The combined panel 1017 may be formed by the panel joining apparatus 1160 of FIG. 11B. The panel joining apparatus 1160 may, for example, include devices for pressing the device panel 1005 and the laser etch stop layer 1205 against the releasable layer 1010 that has been applied to the carrier panel 1015 or the carrier sub-panels. For example, the panel joining apparatus 1160 may include a glass panel “pick and place” apparatus of a type that is used within the LCD industry to join two glass panels. The panel joining apparatus 1160 also may include apparatus for curing the releasable layer 1010, such as apparatus for applying ultraviolet light to the releasable layer 1010 and/or apparatus for heating the combined panel 1017 until the releasable layer 1010 is cured.

In this example, process 1100 continues with block 1107, wherein one or more devices are fabricated on the device panel 1005. FIG. 12D shows an example of a cross-section through the combined panel 1017 and a device layer 1210 after the process of block 1107. The device layer 1210 may, for example, include one or more passive devices such as resistors, capacitors and/or inductors formed by passives-on-glass (POG) forming apparatus 1153 (see FIG. 11B). POG forming apparatus 1153 may include devices such as thin film deposition tools for physical vapor deposition, chemical vapor deposition, evaporation, electroless plating and/or electrolytic plating. POG forming apparatus 1153 may include lithography tools to pattern the device geometry. POG forming apparatus 1153 may include reactive ion etching and/or wet chemical etching tools to etch the films. A combination of processes using such tools may be used to form passive devices on glass panels.

In alternative implementations, devices may be fabricated on the device panel 1005 during a different stage of process 1100. For example, in some implementations, the device layer 1210 may be formed before the device panel 1005 is joined with the carrier panel 1015.

In block 1110 of FIG. 11A, vias are formed through the device layer 1210 and the device panel 1005 using a laser drilling process. The process of block 1110 may be performed using via forming apparatus 1163 depicted in FIG. 11B. FIG. 12E shows an example of a cross-section through the combined panel 1017 and the device layer 1210 after the process of block 1110. In this example, the vias 1020 extend through the device panel 1005 to the laser etch stop layer 1205. Although it may appear that the device layer 1210 is homogeneous, this is not necessarily the case. In some implementations, devices in the device layer 1210 may be positioned in accordance with locations of the vias 1020. For example, devices in the device layer 1210 may be positioned so that they may not be damaged when the vias 1020 are formed. In some implementations, devices in the device layer 1210 may be positioned so that they can be configured for electrical connectivity with conductive material that is disposed in the vias 1020.

FIG. 12F shows an example of a cross-section through the combined panel 1017 and the device layer 1210 after the process of block 1110. In this example, block 1103 of process 1100 has been omitted. Because no laser etch stop layer has been deposited, the vias 1020 formed in block 1110 extend through the device panel 1005 and into the releasable layer 1010. However, the depth of the vias 1020 also can be controlled by regulating the time and amplitude of applied laser power. Therefore, in some implementations that do not include forming a laser etch stop layer, the vias 1020 formed in block 1110 do not extend into the releasable layer 1010.

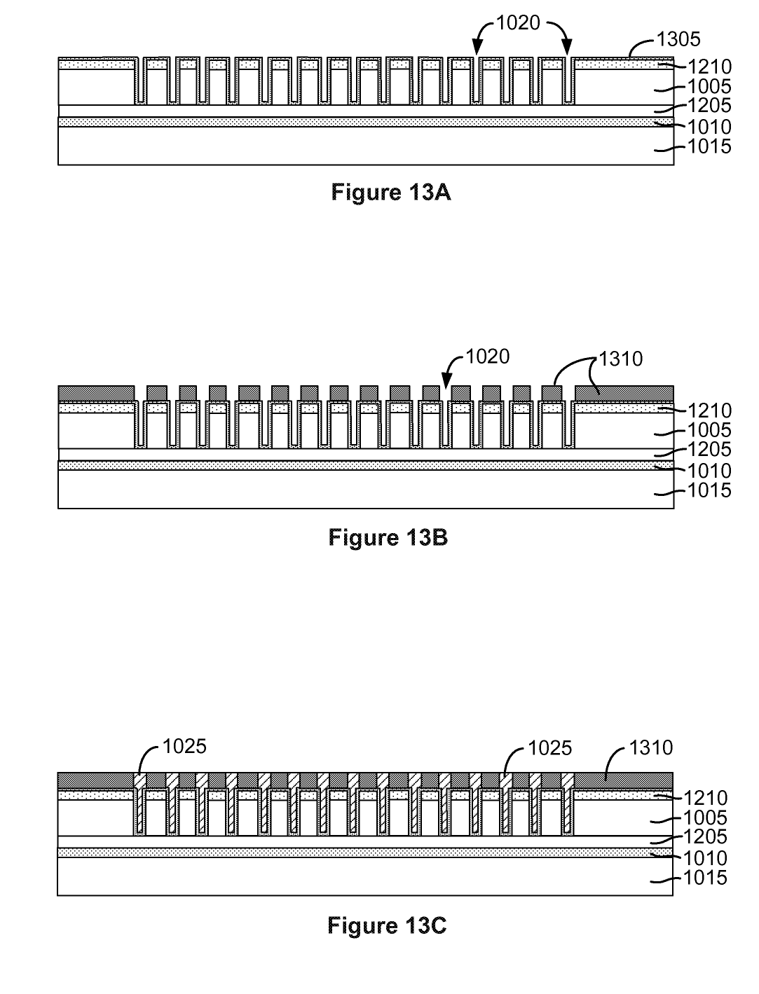

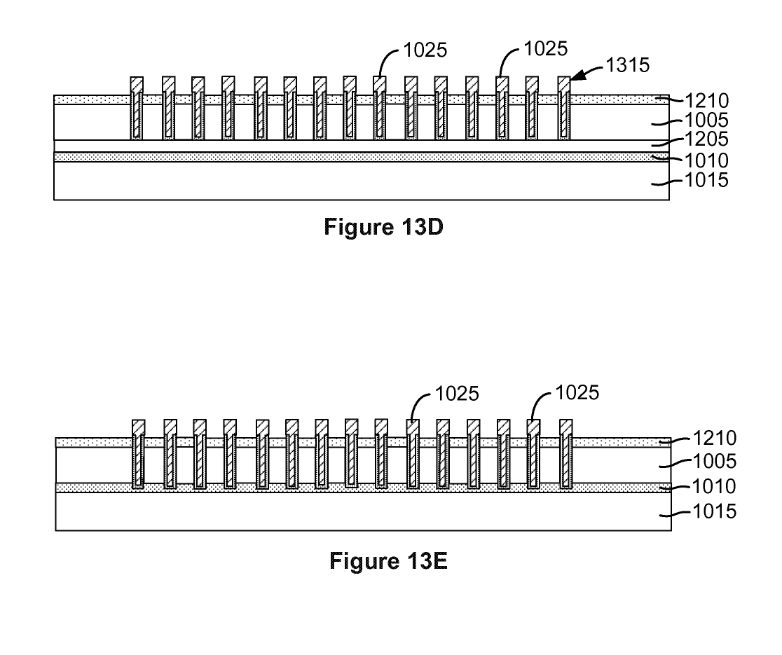

Some implementations involve an electroplating process, preceded by deposition of a seed layer (see optional block 1113). FIG. 13A shows an example of a cross-section through the device after the process of block 1113. The seed layer 1305 has been formed in the vias 1020 and on the device layer 1210. The seed layer 1305 may be formed of various materials, such as nickel, a nickel alloy (such as nickel iron, nickel cobalt or nickel manganese), copper, or gold. In some implementations, an adhesion layer (not shown) may be formed under the seed layer 1305. The adhesion layer may, for example, be formed of chromium, titanium or an alloy such as titanium tungsten (TiW). Accordingly, the via filling apparatus 1165 includes devices for forming the seed layer 1305 and/or the adhesion layer in some implementations. For example, the via filling apparatus 1165 may include devices for forming the seed layer 1305 and/or the adhesion layer by a sputtering process or an atomic layer deposition (ALD) process.

It may be desirable to fill the vias 1020 with conductive material that extends above the upper surface of the device layer 1210. In this implementation, “tents” of photoresist material (or of a similar material) may be formed around the vias 1020 in optional block 1115, allowing the metal deposited during the subsequent electroplating process to be formed above the device layer 1210. During lamination of the photoresist material, the temperature of the lamination film may be tightly controlled by the via filling apparatus 1165. When the temperature is below the reflow temperature of the lamination film, the lamination film can cover the vias without entering the vias. Accordingly, in a subsequent stage (e.g., during exposure and development of the photoresist film), the lamination film may be dissolved out cleanly, leaving little or no residue. This is an example of an advantage of this type of photoresist material over liquid photoresist in creating patterns on substrates with vias and holes.

FIG. 13B shows an example of a cross-section through the device after the process of block 1115. Layer 1310 may be formed of photoresist material, such as DuPont® MX 5000 dry film photoresist. Accordingly, in this example the via filling apparatus 1165 includes devices for forming the layer 1310, such as temperature control devices and devices for applying a lamination film of such photoresist material.

In this example, the next phases of process 1100 involve disposing conductive material into the vias 1020 (see block 1117). Here, these operations are performed by the via filling apparatus 1165 of FIG. 11B. The types of devices included in the via filling apparatus 1165 may vary according to the implementation. For example, the via filling apparatus 1165 may include devices for filling the vias 1020 with a conductive paste. The via filling apparatus 1165 may include pipettes or syringes that may be inserted into the vias 1020 to deliver the conductive paste. The via filling apparatus 1165 may include devices for spreading the conductive paste onto the top of the device layer 1210 and into the vias 1020.

In this example, however, an electroplating process is performed after the layer 1310 has been deposited and, if necessary, cured. Block 1117 may involve filling the vias 1020 by electroplating a metal such as copper, nickel or another suitable metal. Accordingly, the via filling apparatus 1165 may include one or more electroplating tanks with anodes and cathodes, apparatus for providing electricity to the anodes and cathodes, hoists and/or other equipment for handling the combined panel 1017, chemical feeder systems for providing electroplating chemicals, one or more control systems for controlling the other devices, etc.

FIG. 13C shows an example of a cross-section through the device after the process of block 1117. In this example, the conductive material 1025 extends to a top surface of the layer 1310. In alternative examples, the electroplating process may be terminated before the conductive material 1025 extends to the top surface of the layer 1310.

In this implementation, the layer 1310 and those portions of the seed layer 1305 that overlay the device layer 1210 are removed in block 1120. Block 1120 of FIG. 11A may involve etching the layer 1310 and the seed layer 1305 or removal of the layer 1310 and the seed layer 1305 by any other appropriate process. Accordingly, the layer removing apparatus 1175 (see FIG. 11B) may include wet or dry etching equipment, such as chemical etching equipment, ion etching equipment, etc.

FIG. 13D shows an example of a cross-section through the device after the process of block 1120. In this example, portions 1315 of the conductive material 1025 now extend beyond a top surface of the device layer 1210. FIG. 13E shows an example of a cross-section through the device after the process of block 1120 in an alternative implementation that does not involve forming the laser etch stop layer 1205 in block 1103. At this stage, the conductive material 1025 extends beyond the top surface of the device layer 1210 and into the releasable layer 1010.

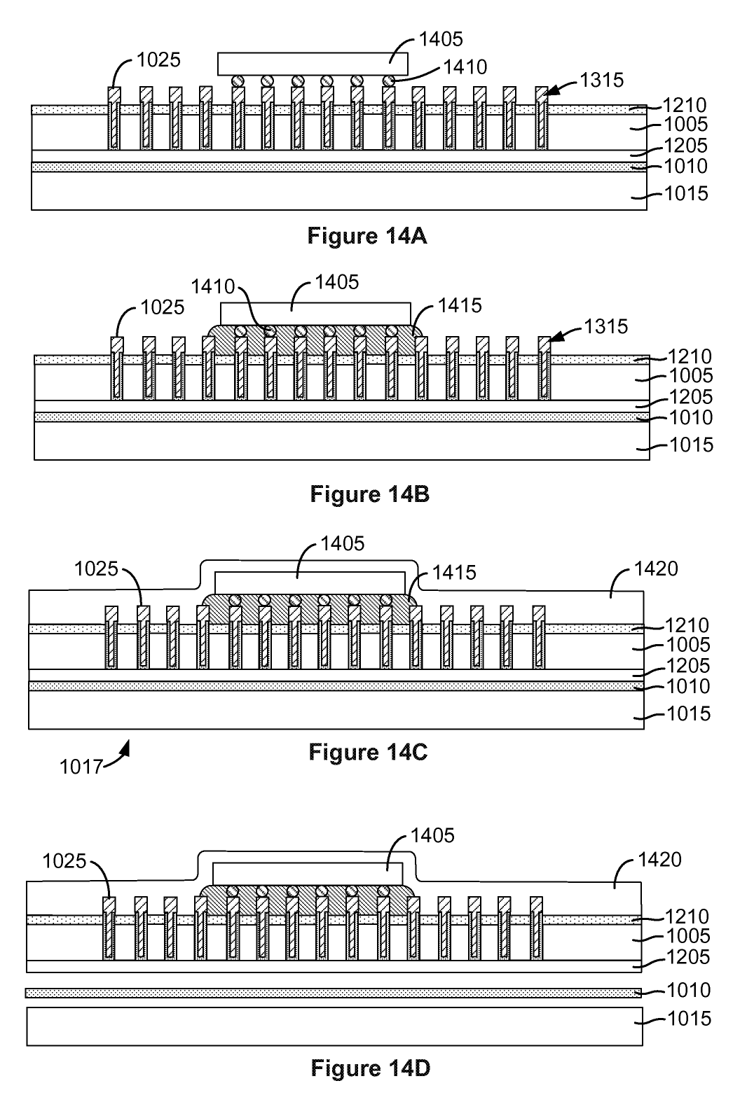

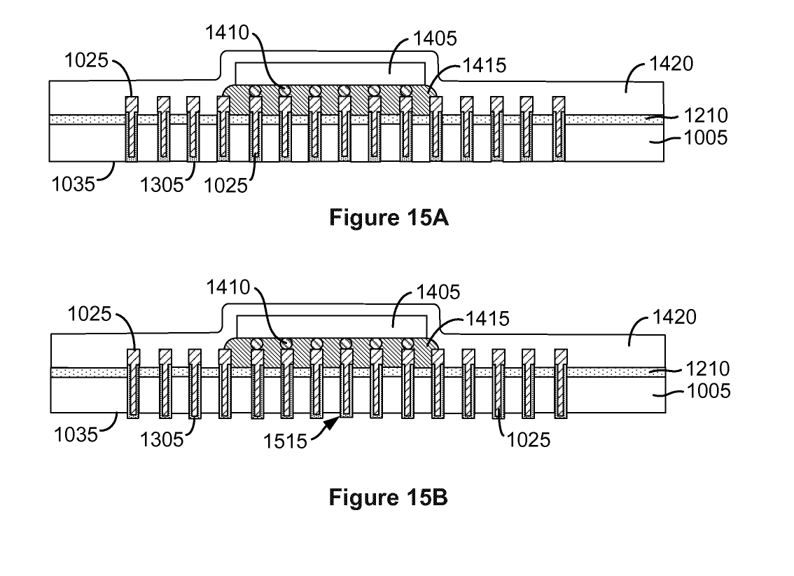

In this example, one or more devices are electrically connected to the conductive material 1025 in block 1123 in FIG. 11A. FIG. 14A shows an example of a cross section wherein an integrated circuit 1405 has been configured for electrical communication with the conductive material 1025 via solder balls 1410. In alternative examples, the integrated circuit 1405 may be configured for electrical communication with the conductive material 1025 via a conductive pillar (e.g., a pillar made of copper) with a solder cap (such as a solder cap made of tin and/or gold). In this example, block 1123 also involves forming an underfill layer 1415 (see FIG. 15B). The underfill layer 1415 may increase adhesion strength and enhance solder joint reliability performance. The underfill layer 1415 may be formed, for example, from materials such as those used for flip chip applications within the microelectronics industry, e.g., underfill materials provided by Namics Corporation. Accordingly, the device connecting apparatus 1167 (see FIG. 11B) may include soldering apparatus and other devices suitable for “flip chip” bonding of the integrated circuit 1405, e.g., pick and place apparatus such as a die bonder available from FineTech, Inc., PacTech, ASM International N.V., Panasonic Corporation, dataCon, Inc. or BE Semiconductor Industries N.V.

Referring back to FIG. 11A, the process 1100 also includes an encapsulation block 1125 in this example. In this example, an overcoat layer 1420 has been deposited over the upper surface of the partially-fabricated device (see FIG. 14C). The overcoat layer 1420 may be formed of any suitable protective material, such as a polyimide layer or a material such as Zeocoat™ provided by Zeon Corporation. Accordingly, the encapsulation apparatus 1169 (see FIG. 11B) may include one or more devices for applying the overcoat layer 1420, for curing the overcoat layer 1420, etc., such as, polymer film lamination and thermal cure apparatus such as that available from GTI Chemical Solutions, LLC, Lintec International LLC or Takatori Corporation.

In block 1127, the carrier panel 1015 is separated from the device panel 1005 by removing the releasable layer 1010 (see FIG. 14D). This process may be carried out by the panel cleaving apparatus 1170 depicted in FIG. 11B. In some implementations, the panel cleaving apparatus 1170 may include one or more laser devices suitable for providing laser irradiation to remove the releasable layer. As noted above, in some such implementations the combined panel 1017 may be divided into sub-panels before laser irradiation of the releasable layer 1010. In some such implementations, the panel cleaving apparatus 1170 may include devices for dividing the combined panel 1017 into sub-panels, such as devices for dicing the carrier panel 1015 or the combined panel 1017, for scoring and breaking the combined panel 1017, etc.

In alternative implementations, the releasable layer 1010 may be dissolved in block 1127. Accordingly, the panel cleaving apparatus 1170 may include devices for providing a wet chemical dissolution agent to release the device panel 1005 from the carrier panel 1015. In some such implementations, the panel cleaving apparatus 1170 may be configured to introduce the dissolution agent through pre-fabricated holes in the carrier panel 1015.

For implementations in which the laser etch stop layer 1205 has been formed on the device panel 1005, the laser etch stop layer 1205 may be removed after the device panel 1005 has been separated from the carrier panel 1015 (block 1130). For example, the laser etch stop layer 1205 may be removed by an etching process. Block 1130 may be performed by layer removing apparatus 1175 (see FIG. 11B).

FIG. 15A shows an example of a cross-section through the device panel 1005 after the laser etch stop layer 1205 has been removed. In this example, the conductive material 1025 and the seed layer 1305 extend to the bottom surface 1035 of the device panel 1005, allowing for convenient electrical connections with the integrated circuit 1405 and devices in the device layer 1210.

FIG. 15B shows an example of a cross-section through the device panel 1005 for an implementation in which no laser etch stop layer was deposited. In this example, the portions 1515 of the conductive material 1025 and/or the seed layer 1305 extend beyond the bottom surface 1035 of the device panel 1005 after the releasable layer 1010 is removed, allowing for even more convenient electrical connections with the integrated circuit 1405 and devices in the device layer 1210. In some such implementations, it may not be necessary to form a conductive pad on the bottom surface 1035 for electrical connectivity with the conductive material 1025.

Block 1135 of FIG. 11A involves final processing procedures. Such procedures may be performed using final processing apparatus 1180 depicted in FIG. 11B. For example, block 1135 may involve singulation processes, such as dicing or similar process. Block 1135 may involve packaging and/or further encapsulation processes. In some implementations, block 1135 may involve configuring a singulated device for electrical connectivity with another device. For example, block 1135 may involve mounting a singulated device on a printed circuit board, incorporating a singulated device in another device, etc.

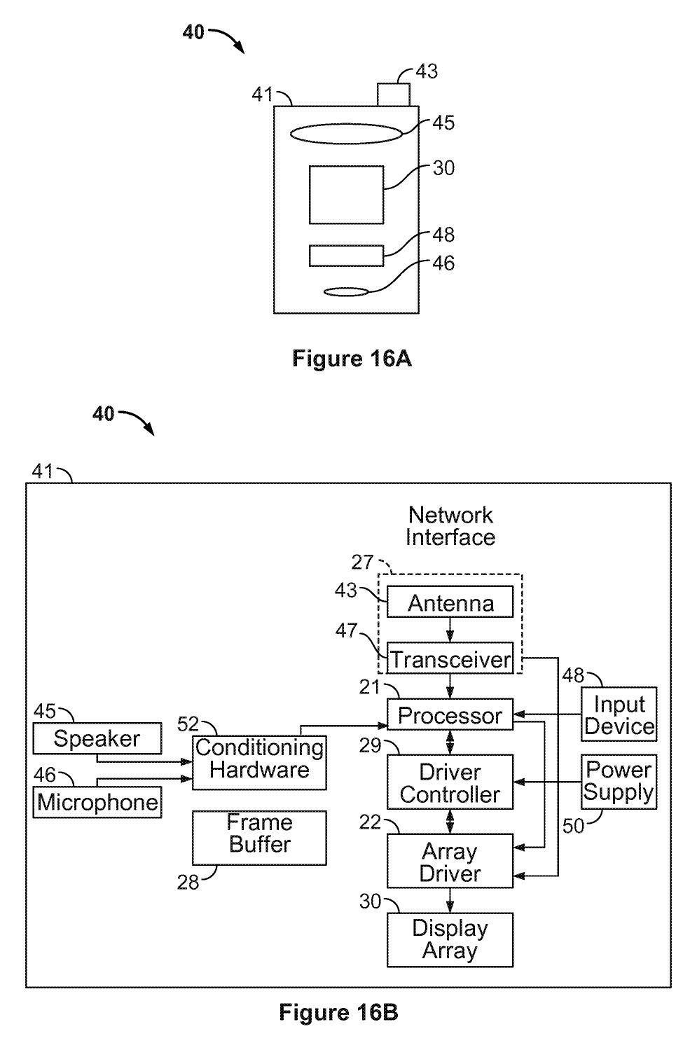

FIGS. 16A and 16B show examples of system block diagrams illustrating a display device that may include one or more devices fabricated as described herein. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 21B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

In some implementations, one or more of the devices shown in FIG. 16B may be fabricated, at least in part, according to processes described herein. For example, the processor 21, the driver controller 29, the conditioning hardware 52 and/or other devices shown in FIG. 16B may be fabricated, at least in part, according to processes described herein.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43. The processor 21 may be configured to receive time data, e.g., from a time server, via the network interface 27.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone integrated circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD (or any other device) as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method, comprising:
joining a device panel and a carrier panel with a releasable layer to form a combined panel;
forming vias through the device panel by laser drilling;
filling the vias with conductive material;
mounting at least one of an integrated circuit and a sensor on a first side of the device panel; and
removing the releasable layer to separate the device panel from the carrier panel.

2. The method of claim 1, wherein removing the releasable layer includes laser irradiation of the releasable layer.

3. The method of claim 1, wherein removing the releasable layer includes performing wet etching on the releasable layer.

4. The method of claim 1, further comprising forming a laser etch stop layer on a second side of the device panel.

5. The method of claim 1, wherein forming the vias includes forming the vias at least partially into the releasable layer and wherein the conductive material protrudes from a second side of the device panel after removing the releasable layer.

6. The method of claim 1, wherein the releasable layer includes a polymer.

7. The method of claim 1, wherein the device panel includes a plurality of device sub-panels and wherein joining the device panel and the carrier panel includes joining the carrier panel with the plurality of device sub-panels.

8. The method of claim 1, further comprising fabricating devices on the first side of the device panel prior to forming the vias.

9. The method of claim 2, further including dividing the combined panel into sub-panels prior to removing the releasable layer.

10. The method of claim 3, wherein the carrier panel includes openings configured for introducing wet etching solvent.

11. The method of claim 7, further comprising dividing the combined panel into sub-panels by dividing the combined panel along interstices between the device sub-panels prior to removing the releasable layer.

12. The method of claim 8, wherein the devices include at least one of a resistor, a capacitor or an inductor.

13. A display device that includes a device panel formed according to the following process:
joining the device panel and a carrier panel with a releasable layer to form a combined panel;
forming vias through the device panel by laser drilling;
filling the vias with conductive material;
mounting an integrated circuit on a first side of the device panel;
forming electrical connections between the integrated circuit and the conductive material; and
removing the releasable layer to separate the device panel from the carrier panel.

14. The display device of claim 13, further comprising:
a display;
a processor that is configured to communicate with the display, the processor being configured to process image data; and
a memory device that is configured to communicate with the processor.

15. The display device of claim 14, further comprising:
a driver circuit configured to send at least one signal to the display; and
a controller configured to send at least a portion of the image data to the driver circuit.

16. The display device of claim 14, further comprising:
an image source module configured to send the image data to the processor.

17. The display device of claim 16, wherein the image source module includes at least one of a receiver, transceiver, and transmitter.

18. The display device of claim 14, further comprising:
an input device configured to receive input data and to communicate the input data to the processor.

19. The display device of claim 14, wherein the device panel includes substantially no stress concentration points on the device substrate.

20. The display device of claim 14, wherein the device panel includes substantially no scratches on the device substrate.

21. A system, comprising:
means for combining a device panel and a carrier panel;
means for forming vias through the device panel;
means for filling the vias with conductive material; and
means for separating the device panel from the carrier panel.

22. The system of claim 21, wherein the means for removing the releasable layer includes laser devices configured to provide laser irradiation of the releasable layer.

23. The system of claim 21, wherein the means for removing the releasable layer includes apparatus for removing the releasable layer by a wet etching process.

24. The system of claim 21, further including means for forming a laser stop layer on a second side of the device panel.

25. The system of claim 21, wherein the means for filling the vias with conductive material includes electroplating apparatus.

26. An apparatus, comprising:
a glass device panel;
a device layer deposited on the device panel, the device layer including at least one passive device;
a carrier panel;
a releasable layer disposed between the device panel and the carrier panel;
a plurality of vias extending through the device panel; and
conductive material disposed in the plurality of vias.

27. The apparatus of claim 26, wherein at least some vias of the plurality of vias extend into the releasable layer.

28. The apparatus of claim 26, further comprising a laser etch stop layer disposed between the releasable layer and the device panel.

29. The apparatus of claim 26, further comprising an integrated circuit configured for electrical communication with the conductive material.

30. The apparatus of claim 29, further comprising an underfill layer disposed between the integrated circuit and the device layer.

31. The apparatus of claim 29, further comprising an overcoat layer formed over the integrated circuit.
